(19) United States
(12) Patent Application Publication
(10) Pub. No.: US 2022/0097480 A1
(43) Pub. Date: Mar. 31, 2022

(54) AIR-CONDITIONING CUSHION FOR VEHICLES

(71) Applicant: SHENZHEN JUNJIAHAO TECHNOLOGY CO., LTD., Shenzhen (CN)

(72) Inventor: Shuting Chen, Shenzhen (CN)

(21) Appl. No.: 17/144,105

(22) Filed: Jan. 7, 2021

(30) Foreign Application Priority Data
Sep. 29, 2020 (CN) 202011053408.7

(51) Int. Cl. B60H 1/00; B60H 1/24

(52) U.S. Cl. CPC B60H 1/00285; B60H 1/246; B60H 1/00471

(57) ABSTRACT

Disclosed is an air-conditioning cushion for vehicles, which includes a seat cushion part, a transmission part and an energy-controlling part; the seat cushion part is connected with the energy-controlling part through the transmission part. The energy-controlling part is detachably mounted at an air outlet of an air conditioner of a vehicle, and cold/hot air from the air conditioner is transmitted to the seat cushion part through an airflow path to cool/heat a human body. The energy-controlling part includes a rear air conditioner cover, a high-speed centrifugal fan, and a front air conditioner cover in sequence according to an assembly order. The front and rear air conditioner covers have shell-like structures corresponding to each other, and an accommodating cavity with a sealed circumference is formed after the front and rear air conditioner covers are assembled. The high-speed centrifugal fan is mounted and fixed inside the accommodating cavity.

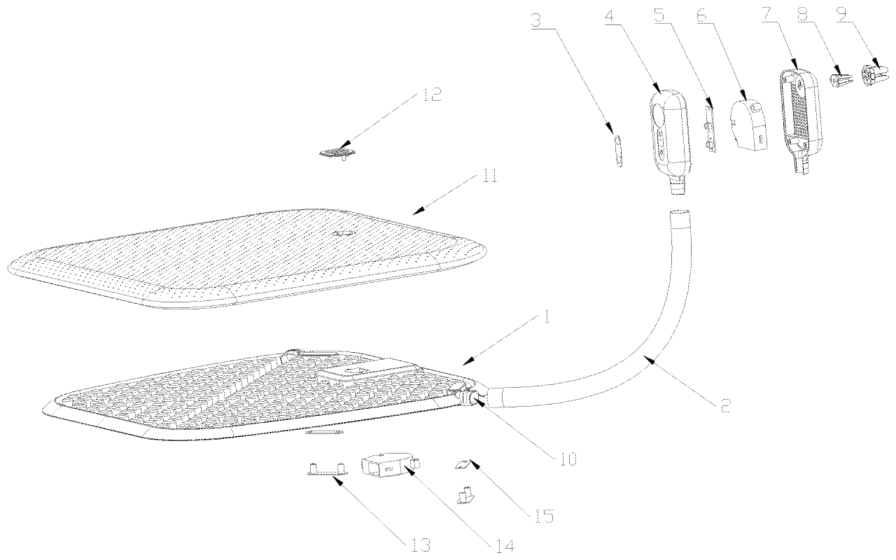

### CROSS REFERENCE TO RELATED APPLICATION

The present application claims priority from Chinese patent application No. 202011053408.7 filed on Sep. 29, 2020, the entire content of which is incorporated herein by reference.

### TECHNICAL FIELD

The present disclosure relates to car accessories, in particularly to an air-conditioning cushion for vehicles.

### BACKGROUND TECHNOLOGY

With the significant improvement of living standards, cars have become an essential travel tool for many families, providing great convenience to people's daily lives. However, during a long period traveling with the car, the driver or passengers in the car are prone to sweating in the lower body, emitting unpleasant smell and breeding bacteria, and even causing serious problems such as skin diseases when the weather is hot. Although there is no concern for sweating in cold weather, a long contact time of the lower body with the cushion and poor ventilation may also cause adverse health effects. Especially under severe weather conditions such as in summer and winter, the comfort and safety conditions are even worse.

### SUMMARY

An objective of the present disclosure is to provide an air-conditioning cushion for vehicles, overcoming defects in the prior art.

The following technical proposal is applied in order to achieve the above-mention objective: an air-conditioning cushion for vehicles, which includes a seat cushion part, a transmission part and an energy-controlling part; the seat cushion part is connected with the energy-controlling part through the transmission part.

The energy-controlling part is detachably mounted at an air outlet of an air conditioner of a vehicle, and cold/hot air from the air conditioner is transmitted to the seat cushion part through an airflow path formed by the transmission part to cool/heat a human body.

Further, the energy-controlling part includes a PVC switch sheet, a rear air conditioner cover, a control mainboard, a first high-speed centrifugal fan, and a front air conditioner cover in sequence according to an assembly order.

The front air conditioner cover and the rear air conditioner cover have shell-like structures corresponding to each other. An accommodating cavity with a sealed circumference is formed after the front air conditioner cover and the rear air conditioner cover are assembled. The control mainboard and the first high-speed centrifugal fan are mounted and fixed inside the accommodating cavity.

Further, the energy-controlling part further includes a magnet for a mobile phone holder, which is arranged inside the accommodating cavity and is attached to an inner surface of the front air conditioner cover.

Further, a metal bracket buckle is provided on an outer side of the rear air conditioner cover, the energy-controlling part is detachably connected to the air outlet of the air conditioner by the metal bracket buckle. A rubber fixing member is sleeved on an outer periphery of the metal bracket buckle.

Further, the seat cushion part includes a PE cushion and a fabric cover/leather cover covering the PE cushion.

Further, an air discharging assembly is arranged on an upper part of the PE cushion at a position fitting with a crotch part of human body while seating, and a bottom part of the air discharging assembly is equipped with a connecting wire cover, a second high-speed centrifugal fan and a connecting wire board; a through-hole is opened on the fabric cover/leather cover at a position corresponding to the air discharging assembly, and an air outlet cover is arranged on the through-hole.

Further, a plurality of hollow regions are evenly distributed on upper and lower surfaces of the PE cushion, and an air passage are formed between the hollow regions for transmitting amplified air from the air conditioner of the vehicle.

Further, symmetrical cushion air inlets are provided at left and right corners of the PE cushion, the cushion air inlets are connected to an air outlet end of the transmission part, the cushion air inlet at the right corner is for a driver's seat, and the cushion air inlet on the left corner is for a front passenger's seat.

Further, the transmission part is a PE air guiding tube, and the PE air guiding tube is a PE tube/rubber tube/silicone tube/fiber tube.

Further, the energy-controlling part is connected to and powered by an external cigarette lighter through a USB cable, and the energy-controlling part is controlled with multiple levels through a wire switch in the cigarette lighter.

Compared with the prior art, the present disclosure has the following advantageous effects: the air-conditioning cushion for vehicles provided by the present disclosure transfers and amplifies the air discharged from the air conditioner, and adjusts the temperature of the cushion underneath the passenger according to real-time temperature conditions inside the vehicle. This avoids temperatures being too hot or too cold, hence improves ride comfort. Keeping warm in winter and cool in summer, comfortable and refreshing, effectively anti-sweat and anti-bacterial, by adjusting the temperature of the air-conditioning cushion for vehicles, the risk of physical fatigue, sleepiness, and traffic accidents caused by heat accumulation may be reduced. Due to the conversion and use of wind from the air conditioner of the vehicle, energy is effectively saved and the use value and economic benefits of cars are improved.

The above-described is only an overview of a technical proposal of the present disclosure, and can be implemented in accordance with the content of the description to more clearly understand the technical means of the present disclosure. In order to make the above and other objectives, features and advantages of the present disclosure more obvious and easier to understand, the following specific embodiments are described in detail as follows.

### BRIEF DESCRIPTION OF THE DRAWINGS

The sole FIGURE is an exploded view of the air-conditioning cushion for vehicles.

### REFERENCE SIGNS

1 PE cushion, 2 PE air guiding tube, 3 PVC switch sheet, 4 rear air conditioner cover, 5 wire switch, 6 first high-speed centrifugal fan, 7 front air conditioner cover, 8 metal bracket buckle, 9 rubber fixing member, 10 cushion air inlet, 11 fabric cover/leather cover, 12 air outlet cover, 13 connecting wire cover, 14 second high-speed centrifugal fan, 15 connecting wire board.

### DESCRIPTION OF THE EMBODIMENTS

In order to make the objectives, technical proposals and advantages of the present disclosure clearer, the present disclosure will be further described in detail below with reference to the accompanying drawings and specific embodiments.

The technical proposals in the embodiments of the present disclosure will be clearly and completely described in conjunction with the accompanying drawings in the embodiments of the present disclosure. It is apparent that the described embodiments are merely part of the embodiments of the present disclosure rather than all embodiments. Based on the embodiments of the present disclosure, all other embodiments obtained by those skilled in the art without creative work fall within the scope of protection of the present disclosure.

In the description of the present disclosure, it should be understood that the terms “center”, “longitudinal direction”, “transverse direction”, “length”, “width”, “thickness”, “upper”, “lower”, “front”, ““rear”, “left”, “right”, “vertical”, “horizontal”, “top”, “bottom”, “inner”, “outer”, “clockwise”, “counterclockwise” etc. indicate spatial relationship that is based on the orientation or positional relationship shown in the drawings, and is only for the convenience of describing the application and simplifying the description, rather than indicating or implying that the device or element referred to must have a specific orientation and be constructed and operated in a specific orientation, therefore these cannot be understood as a limitation to the present disclosure.

In addition, the terms “first” and “second” are used for descriptive purposes only, and cannot be understood as indicating or implying relative importance or implicitly indicating the number of technical features referred to. Therefore, the features defined as “first” and “second” may explicitly or implicitly include one or more of the features. In the description of the present disclosure, the meaning of “plurality” is two or more, unless otherwise specified.

In the present application, unless otherwise clearly specified and limited, the terms “installation”, “connected”, “connected”, “fixed” and other terms should be interpreted as broad meaning, for example, it may be connected or detachably connected, or formed into one entity; It may be a physical connection or electrical connection; it may be directly connected, or it may be indirectly connected through an intermediate medium; it may be an internal communication or interaction between two elements. Those skilled in the art can understand the specific meanings of the above terms in the present disclosure according to specific situations.

In the present application, unless otherwise clearly specified and defined, the first feature “above” or “below” the second feature may include the direct contact of the first and second feature, or may include the first and second features not in direct contact but through another feature therebetween. Moreover, the first feature is “on”, “above” and “over” the second feature includes that the first feature is directly above and obliquely above the second feature, or simply means that the first feature is higher in level than the second feature. The first feature is “under”, “below” and “underneath” the second feature includes that the first feature is directly below and obliquely below the second feature, or simply means that the first feature is lower in level than the second feature.

In the description of the present disclosure, the description referring to the terms “one embodiment”, “some embodiments”, “examples”, “specific examples”, or “some examples” means the specific features, structures, materials or characteristics described in conjunction with the embodiment or examples is included in at least one embodiment or example of the present disclosure. In the present disclosure, the illustrative expression of the above terms should not be understood as having to refer to the same embodiment or example. Moreover, the specific features, structures, materials, or characteristics described may be combined in any suitable manner in any one or more embodiments or examples. In addition, those skilled in the art may bind and combine different embodiments or examples described in the present disclosure.

Referring to the sole FIGURE, Embodiment 1 provides an air-conditioning cushion for vehicles, which includes a seat cushion part, a transmission part and a control part, and the seat cushion part is connected with the control part through the transmission part.

The energy-controlling part is detachably mounted at an air outlet of an air conditioner of a vehicle, and cold/hot air from the air conditioner is transmitted through an air flow path formed by the transmission part to the seat cushion part to cool/heat a human body.

The energy-controlling part includes a PVC switch sheet 3, a rear air conditioner cover 4, a control mainboard, a first high-speed centrifugal fan 6 and a front air conditioner cover 7 in sequence according to their assembly order.

The front air conditioner cover 7 and the rear air conditioner cover 4 have shell-like structures corresponding to each other. An accommodating cavity with a sealed circumference is formed after the front air conditioner cover 7 and the rear air conditioner cover 4 are assembled. The control mainboard and the first high-speed centrifugal fan 6 are mounted and fixed inside the accommodating cavity. By covering an air outlet of the air conditioner with the front air conditioner cover 7 and the rear air conditioner cover 4 of the energy-controlling part, cold or hot air is amplified when it passes through the first high-speed centrifugal fan 6 and transmitted to the seat cushion part through the transmission part, and then the air is transmitted to a position at a passenger's lower body.

The energy-controlling part further includes a magnet for a mobile phone holder, which is arranged in the accommodating cavity and is attached to an inner surface of the front air conditioner cover 7. The magnet for a mobile phone holder and the first high-speed centrifugal fan 6 have a gap therebetween to prevent the operation of the first high-speed centrifugal fan 6 adversely affecting magnetism of the magnet. Additionally, the magnet for a mobile phone holder is attached to the rear air conditioner cover 4, which provides a mounting position for a mobile phone, allowing the driver to use the mobile phone for navigation during the trip.

A metal bracket buckle 8 is provided on an outer side of the rear air conditioner cover 4. The energy-controlling part is detachably connected to the air outlet of the air conditioner through the metal bracket buckle 8. A rubber fixing member 9 is sleeved on the metal bracket buckle 8. High friction of the rubber material of the rubber fixing member 9 ensures that the energy-controlling part of the air-conditioning cushion for vehicles is clamped and mounted on the fan of the air outlet of the air conditioner more stably and reliably.

The seat cushion part includes a PE cushion 1 and a fabric cover/leather cover 11 covering the PE cushion 1. A plurality of hollow regions are evenly distributed on upper and lower surfaces of the PE cushion 1, and an air passage is formed between the hollow regions for transmitting amplified air from the air conditioner of the vehicle. Further, symmetrical cushion air inlets 10 are provided at left and right corners of the PE cushion 1, the cushion air inlets 10 are connected to an air outlet end of the transmission part, the cushion air inlet 10 at the right corner is for a driver's seat, and the cushion air inlet 10 on the left corner is for a passenger's seat. Since the PE cushion 1 has a hollow structure, a large amount of air is output from the hollow regions, and the material of the PE cushion 1 is relatively hard, therefore, covering the PE cushion 1 with soft and air permeable fabric cover/leather cover 11 may effectively filter and soften the outgoing airflow, and improve the comfort of use. Moreover, the fabric cover/leather cover 11 may also effectively prevent water stains, dust and other impurities in the environment from entering the hollow part of the PE cushion 1 and causing trouble to cleaning and antibacterial. More specifically, the fabric cover/leather cover covered on the periphery of the PE cushion 1 may also be made of other air permeable and soft materials. An air discharging assembly is arranged on an upper part of the PE cushion 1 at a position fitting with a crotch part of human body while seating, and a bottom part of the air discharging assembly is equipped with a connecting wire cover 13, a second high-speed centrifugal fan 14 and a connecting wire board 15. A through-hole is opened on the fabric cover/leather cover 11 at a position corresponding to the air discharging assembly, and an air outlet cover 12 is arranged on the through-hole.

The transmission part is a PE air guiding tube 2, and the PE air guiding tube 2 is a PE tube/rubber tube/silicone tube/fiber tube.

The energy-controlling part is connected to and powered by an external cigarette lighter through a USB cable, and the energy-controlling part is controlled with multiple levels through a wire switch 5 in the cigarette lighter.

Embodiment 2 provides an air-conditioning cushion for vehicles, which includes a seat cushion part, a transmission part, and an energy-controlling part. The seat cushion part is connected to the energy-controlling part through the transmission part.

The energy-controlling part is detachably mounted at an air outlet of an air conditioner of a vehicle, and cold/hot air from the air conditioner is transmitted to the seat cushion part through an airflow path formed by the transmission part to cool/heat a human body.

The energy-controlling part includes a PVC switch sheet 3, a rear air conditioner cover 4, a control mainboard, a first high-speed centrifugal fan 6 and a front air conditioner cover 7 in sequence according to their assembly order.

The front air conditioner cover 7 and the rear air conditioner cover 4 have shell-like structures corresponding to each other. An accommodating cavity with a sealed circumference is formed after the front air conditioner cover 7 and the rear air conditioner cover 4 are assembled. The control mainboard and the first high-speed centrifugal fan 6 are mounted and fixed inside the accommodating cavity. By covering the air outlet of the air conditioner with the front air conditioner cover 7 and the rear air conditioner cover 4 of the energy-controlling part, cold or hot air is amplified when it passes through the first high-speed centrifugal fan 6 and transmitted to the seat cushion part through the transmission part, and is further transmitted to the position corresponding to a passenger's lower body.

The energy-controlling part further includes a magnet for a mobile phone holder, which is arranged in the accommodating cavity and is attached to an inner surface of the front air conditioner cover 7. The magnet for a mobile phone holder and the first high-speed centrifugal fan 6 have a gap therebetween to prevent the operation of the first high-speed centrifugal fan 6 adversely affecting magnetism of the magnet. Additionally, the magnet for a mobile phone holder is attached to the rear air conditioner cover 4, which provides a mounting position for a mobile phone, allowing the driver to use the mobile phone for navigation during the trip.

A metal bracket buckle 8 is provided on an outer side of the rear air conditioner cover 4. The energy-controlling part is detachably connected to the air outlet of the air conditioner through the metal bracket buckle 8. A rubber fixing member 9 is sleeved on the metal bracket buckle 8. High friction of the rubber material of the rubber fixing member 9 ensures that the energy-controlling part of the air-conditioning cushion for vehicles is clamped and mounted on the fan of the air outlet of the air conditioner more stably and reliably.

The seat cushion part includes a PE cushion 1 and a fabric cover/leather cover 11 covering the PE cushion 1. A plurality of hollow regions are evenly distributed on upper and lower surfaces of the PE cushion 1, and an air passage is formed between the hollow regions for transmitting amplified air from the air conditioner. Further, symmetrical cushion air inlets 10 are provided at left and right corners of the PE cushion 1, the cushion air inlets 10 are connected to an air outlet end of the transmission part, the cushion air inlet 10 at the right corner is for a driver's seat, and the cushion air inlet 10 on the left corner is for a passenger's seat. Since the PE cushion 1 has a hollow structure, a large amount of air is output from the hollow regions, and the material of the PE cushion 1 is relatively hard, therefore, covering the PE cushion 1 with soft and air permeable fabric cover/leather cover 11 may effectively filter and soften the outgoing airflow, and improve the comfort of use. Moreover, the fabric cover/leather cover 11 may also effectively prevent water stains, dust and other impurities in the environment from entering the hollow part of the PE cushion 1 and causing trouble to cleaning and antibacterial. More specifically, the fabric cover/leather cover covered on the periphery of the PE cushion 1 may also be made of other air permeable and soft materials. An air discharging assembly is arranged on an upper part of the PE cushion 1 at a position fitting with a crotch part of human body while seating, and a bottom part of the air discharging assembly is equipped with a connecting wire cover 13, a second high-speed centrifugal fan 14 and a connecting wire board 15. A through-hole is opened on the fabric cover/leather cover 11 at a position corresponding to the air discharging assembly, and an air outlet cover 12 is arranged on the through-hole.

The transmission part is a PE air guiding tube 2, and the PE air guiding tube 2 is a PE tube/rubber tube/silicone tube/fiber tube.

The energy-controlling part is connected to and powered by an external cigarette lighter through a USB cable, and the energy-controlling part is controlled with multiple levels through a wire switch 5 in the cigarette lighter.

The present embodiment differs from Embodiment 1 in that an outer periphery of the front air conditioner cover 7 is equipped with a vacuum suction cup which has a size matching a size of an outer ring of the air outlet of the air conditioner, so that the energy-controlling part is closely attached to an outer side of the air conditioner through the vacuum suction cup. Since the space inside the vacuum suction cup completely covers the air outlet of the air conditioner, air from the air outlet of the air conditioner may all enter into the energy-controlling part, and is amplified when it passes through the first high-speed centrifugal fan 6 to increase the air volume. The amplified air is transmitted to the seat cushion part through the PE air guiding tube 2 of the transmission part, and is further transmitted to the second high-speed centrifugal fan 14 through hollow passages defined by protrusions on the PE seat cushion 1, and the air is further amplified by the second high-speed centrifugal fan 14. The amplified air is output through the air outlet cover 12 of the air discharging assembly in the middle of the PE cushion 1 that fits the crotch part of a human body. The air from the air outlet of the air conditioner is collected and amplified to the greatest extent, and is transmitted to the crotch part of the human body, allowing the crotch part to keep cool and dry and inhibiting the growth of bacteria. In addition, the vacuum suction cup cooperate with the metal bracket buckle 8 and the rubber fixing member 9 to ensure a stable and reliable connection between the energy-controlling part and the air outlet of the air conditioner.

Embodiment 3 provides an air-conditioning cushion for vehicles, which includes a seat cushion part, a transmission part, and an energy-controlling part. The seat cushion part is connected to the energy-controlling part through the transmission part.

The energy-controlling part is detachably mounted at an air outlet of an air conditioner, and cold/hot air from the air conditioner is transmitted to the seat cushion part through an airflow path formed by the transmission part to cool/heat a human body.

The energy-controlling part includes a PVC switch sheet 3, a rear air conditioner cover 4, a control mainboard, a first high-speed centrifugal fan 6 and a front air conditioner cover 7 in sequence according to their assembly order.

The front air conditioner cover 7 and the rear air conditioner cover 4 have shell-like structures corresponding to each other. An accommodating cavity with a sealed circumference is formed after the front air conditioner cover 7 and the rear air conditioner cover 4 are assembled. The control mainboard and the first high-speed centrifugal fan 6 are mounted and fixed inside the accommodating cavity. By covering the air outlet of the air conditioner with the front air conditioner cover 7 and the rear air conditioner cover 4 of the energy-controlling part, cold or hot air is amplified when it passes through the first high-speed centrifugal fan 6 and transmitted to the seat cushion part through the transmission part, and is further transmitted to the position at a passenger's lower body.

The energy-controlling part further includes a magnet for a mobile phone holder, which is arranged in the accommodating cavity and is attached to an inner surface of the front air conditioner cover 7. The magnet for a mobile phone holder and the first high-speed centrifugal fan 6 have a gap therebetween to prevent the operation of the first high-speed centrifugal fan 6 adversely affecting magnetism of the magnet. Additionally, the magnet for a mobile phone holder is attached to the rear air conditioner cover 4, which provides a mounting position for a mobile phone, allowing the driver to use the mobile phone for navigation during the trip.

The seat cushion part includes a PE cushion 1 and a fabric cover/leather cover 11 covering the PE cushion 1. A plurality of hollow regions are evenly distributed on upper and lower surfaces of the PE cushion 1, and an air passage is formed between the hollow regions for transmitting amplified air from the air conditioner. Further, symmetrical cushion air inlets 10 are provided at left and right corners of the PE cushion 1, the cushion air inlets 10 are connected to an air outlet end of the transmission part, the cushion air inlet 10 at the right corner is for a driver's seat, and the cushion air inlet 10 on the left corner is for a passenger's seat. Since the PE cushion 1 has a hollow structure, a large amount of air is output from the hollow regions, and the material of the PE cushion 1 is relatively hard, therefore, covering the PE cushion 1 with soft and air permeable fabric cover/leather cover 11 may effectively filter and soften the outgoing airflow, and improve the comfort of use. Moreover, the fabric cover/leather cover 11 may also effectively prevent water stains, dust and other impurities in the environment from entering the hollow part of the PE cushion 1 and causing trouble to cleaning and antibacterial. More specifically, the fabric cover/leather cover covered on the periphery of the PE cushion 1 may also be made of other air permeable and soft materials. An air discharging assembly is arranged on an upper part of the PE cushion 1 at a position fitting with a crotch part of human body while seating, and a bottom part of the air discharging assembly is equipped with a connecting wire cover 13, a second high-speed centrifugal fan 14 and a connecting wire board 15. A through-hole is opened on the fabric cover/leather cover 11 at a position corresponding to the air discharging assembly, and an air outlet cover 12 is arranged on the through-hole.

The transmission part is a PE air guiding tube 2, and the PE air guiding tube 2 is a PE tube/rubber tube/silicone tube/fiber tube.

The energy-controlling part is connected to and powered by an external cigarette lighter through a USB cable, and the energy-controlling part is controlled with multiple levels through a wire switch 5 in the cigarette lighter.

The present embodiment differs from Embodiments 1 and 2 in that a vacuum suction cup is further provided, and the metal bracket buckle 8 and the rubber fixing member 9 are omitted, so that the overall structure has less components and is further simplified. The vacuum suction cup that has a size matching a size of an outer ring of the air outlet of the air conditioner is arranged on an outer periphery of the front air conditioner cover 7, so that the energy-controlling part is closely attached to an outer side of the air conditioner through the vacuum suction cup. Since the space inside the vacuum suction cup completely covers the air outlet of the air conditioner, air from the air outlet of the air conditioner may all enter into the energy-controlling part, and is amplified when it passes through the first high-speed centrifugal fan 6 to increase the air volume. The amplified air is transmitted to the seat cushion part through the PE air guiding tube 2 of the transmission part, and is further transmitted to the second high-speed centrifugal fan 14 through hollow passages defined by protrusions on the PE seat cushion 1, and the air is further amplified by the second high-speed centrifugal fan 14. The amplified air is output through the air outlet cover 12 of the air discharging assembly in the middle of the PE cushion 1 that fits the crotch part of a human body. The air from the air outlet of the air conditioner is collected and amplified to the greatest extent, and is transmitted to the crotch part of the human body, allowing the crotch part to keep cool and dry and inhibiting the growth of bacteria.

Compared with the prior art, the present disclosure has the following advantageous effects: the air-conditioning cushion for vehicles provided by the present disclosure transfers and amplifies the air discharged from the air conditioner, and adjusts the temperature of the cushion underneath the passenger according to real-time temperature conditions inside the vehicle. This avoids temperatures being too hot or too cold, hence improves ride comfort. Keeping warm in winter and cool in summer, comfortable and refreshing, effectively anti-sweat and anti-bacterial, by adjusting the temperature of the air-conditioning cushion for vehicles, the risk of physical fatigue, sleepiness, and traffic accidents caused by heat accumulation may be reduced. Due to the conversion and use of wind from the air conditioner, energy is effectively saved and the use value and economic benefits of cars are improved.

The above uses embodiments merely to further illustrate the technical content of the present disclosure for easier understanding of the reader, but does not intend to limit the implementation of the present disclosure thereto. Any technical extension or re-creation made according to the present disclosure shall fall within the scope of protection of the present disclosure. The scope of protection of the present disclosure is defined by the appended claims.

What is claimed is:

1. An air-conditioning cushion for vehicles, comprising a seat cushion part, a transmission part and an energy-controlling part, the seat cushion part is connected with the energy-controlling part through the transmission part;
the energy-controlling part is detachably mounted at an air outlet of an air conditioner of a vehicle, and cold/hot air from the air conditioner is transmitted to the seat cushion part through an airflow path formed by the transmission part to cool/heat a human body.

2. The air-conditioning cushion for vehicles according to claim 1, wherein the energy-controlling part includes a PVC switch sheet, a rear air conditioner cover, a control mainboard, a first high-speed centrifugal fan, and a front air conditioner cover in sequence according to an assembly order;
the front air conditioner cover and the rear air conditioner cover have shell-like structures corresponding to each other, an accommodating cavity with a sealed circumference is formed after the front air conditioner cover and the rear air conditioner cover are assembled, the control mainboard and the first high-speed centrifugal fan are mounted and fixed inside the accommodating cavity.

3. The air-conditioning cushion for vehicles according to claim 2, wherein the energy-controlling part further comprises a magnet for a mobile phone holder, which is arranged inside the accommodating cavity and is attached to an inner surface of the front air conditioner cover.

4. The air-conditioning cushion for vehicles according to claim 3, wherein a metal bracket buckle is provided on an outer side of the rear air conditioner cover, the energy-controlling part is detachably connected to the air outlet of the air conditioner by the metal bracket buckle, a rubber fixing member is sleeved on an outer periphery of the metal bracket buckle.

5. The air-conditioning cushion for vehicles according to claim 4, wherein the seat cushion part comprises a PE cushion and a fabric cover/leather cover covering the PE cushion.

6. The air-conditioning cushion for vehicles according to claim 5, wherein an air discharging assembly is arranged on an upper part of the PE cushion at a position fitting with a crotch part of human body while seating, and a bottom part of the air discharging assembly is equipped with a connecting wire cover, a second high-speed centrifugal fan and a connecting wire board; a through-hole is opened on the fabric cover/leather cover at a position corresponding to the air discharging assembly, and an air outlet cover is arranged on the through-hole.

7. The air-conditioning cushion for vehicles according to claim 6, wherein a plurality of hollow regions are evenly distributed on upper and lower surfaces of the PE cushion, and an air passage are formed between the hollow regions for transmitting amplified air from the air conditioner of the vehicle.

8. The air-conditioning cushion for vehicles according to claim 7, wherein symmetrical cushion air inlets are provided at left and right corners of the PE cushion, the cushion air inlets are connected to an air outlet end of the transmission part, the cushion air inlet at the right corner is for a driver's seat, and the cushion air inlet on the left corner is for a front passenger's seat.

9. The air-conditioning cushion for vehicles according to claim 1, wherein the transmission part is a PE air guiding tube, and the PE air guiding tube is a PE tube/rubber tube/silicone tube/fiber tube.

10. The air-conditioning cushion for vehicles according to claim 1, wherein the energy-controlling part is connected to and powered by an external cigarette lighter through a USB cable, and the energy-controlling part is controlled with multiple levels through a wire switch in the cigarette lighter.
